(19) United States
(12) Patent Application Publication
(10) Pub. No.: US 2024/0417498 A1
(43) Pub. Date: Dec. 19, 2024

(54) BLOCKY POLYVINYL ALCOHOL POLYMERS

(71) Applicant: Sekisui Specialty Chemicals America, LLC, Pasadena, TX (US)

(72) Inventors: Richard Vicari, Pasadena, TX (US); Regan Pollock, Houston, TX (US); Kazuhiro Sawa, Pasadena, TX (US)

(73) Assignee: Sekisui Specialty Chemicals America, LLC, Pasadena, TX (US)

(21) Appl. No.: 18/744,155

(22) Filed: Jun. 14, 2024

Related U.S. Application Data
(60) Provisional application No. 63/508,369, filed on Jun. 15, 2023.

(51) Int. Cl. C08F 216/06; C08J 5/18

(52) U.S. Cl. CPC C08F 216/06; C08J 5/18; C08J 2329/04

(57) ABSTRACT

A sulfonic acid modified polyvinyl alcohol resin including about 3 mol % to about 12 mol % of a comonomer including a sulfonic acid group, and a blockiness index η of the sulfonic acid group of between about 0.2 to about 0.4 according to the Modified Moritani Method.

### CROSS-REFERENCE TO RELATED APPLICATIONS

This application claims the benefit of U.S. Provisional Application No. 63/508,369 filed Jun. 15, 2023, the entire contents of which are hereby incorporated by reference.

### BACKGROUND

The present disclosure relates in general to polyvinyl alcohol (PVOH) polymers and formulations, and more particularly, to modified PVOH polymers having improved chemical and mechanical properties.

All of the subject matter discussed in the Background section is not necessarily prior art and should not be assumed to be prior art merely as a result of its discussion in the Background section. Along these lines, any recognition of problems in the prior art discussed in the Background section or associated with such subject matter should not be treated as prior art unless expressly stated to be prior art. Instead, the discussion of any subject matter in the Background section should be treated as part of the inventor's approach to the particular problem, which in and of itself may also be inventive.

PVOH is a common synthetic polymer used in numerous industrial applications including but not limited to papermaking and packaging, protective coatings and films, adhesives, thickening agents, and textiles. This is due to the fact that PVOH is a versatile polymer with numerous advantages, including water solubility, film forming ability, adhesive properties (e.g., good adhesion and tackiness), biocompatibility, thermal stability, optical clarity, and chemical resistance.

However, despite its versatility, PVOH has been known to lack certain desirable features, such as good oxygen transmission rate (OTR) for packaging and other applications that require high barrier properties against oxygen at high humidity. PVOH is a hydrophilic polymer and thus typically exhibits poor barrier properties against water vapor, but can be an effective barrier against oxygen for lower humidity applications, such as below about 60% relative humidity (RH).

Consequently, PVOH is often used in combination with other barrier materials to improve its barrier properties against oxygen. For example, PVOH can be laminated with EVOH to create a multi-layer film with improved barrier properties.

However, it would be desirable to produce a PVOH polymer and film that has improved oxygen barrier properties particularly at high humidity, ideally while preserving or even improving one or more of the other desirable features of the polymer.

### BRIEF SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, a sulfonic acid modified polyvinyl alcohol resin may include a blockiness index η of the sulfonic acid group of between about 0.2 to about 0.4 according to the Modified Moritani Method described further herein.

In another aspect, a sulfonic acid modified polyvinyl alcohol resin may include from about 3 to about 12 mol % of a comonomer includes a sulfonic acid group, and a crystallinity of between about 10% to about 25% as measured by differential scanning calorimetry (DSC).

In yet another aspect, the sulfonic acid modified polyvinyl alcohol resin may include a sequence length I_{AMPS} of between about 3.3 to about 5.1 according to the Modified Moritani Method described further herein.

Other technical features may be readily apparent to one skilled in the art from the following figures, descriptions, and claims.

### BRIEF DESCRIPTION OF THE SEVERAL VIEWS OF THE DRAWINGS

FIG. 1 shows the results of TABLE 1 polymerization including solution viscosity and ¹³C NMR compositional analysis of modified polyvinyl alcohol samples of the present disclosure.

FIG. 2A shows the results of TABLE 2A differential scanning calorimetry (DSC) analysis of modified polyvinyl alcohol samples of the present disclosure.

FIG. 2B shows the results of TABLE 2B differential scanning calorimetry (DSC) analysis of modified polyvinyl alcohol samples of the present disclosure.

FIG. 3 shows the results of TABLE 3 calculating the blockiness index and sequence length of modified polyvinyl alcohol samples of the present disclosure.

FIG. 4A shows TABLE 4A ¹³C NMR integral measurements of modified polyvinyl alcohol samples of the present disclosure.

FIG. 4B shows the TABLE 4B results of calculating the blockiness index and sequence length of modified polyvinyl alcohol samples of the present disclosure.

FIG. 4C shows the TABLE 4C results of calculating the blockiness index and sequence length of modified polyvinyl alcohol samples of the present disclosure.

FIG. 5 shows the TABLE 5 results of solubility testing of modified polyvinyl alcohol film samples of the present disclosure.

FIG. 6A shows the TABLE 6 results of mechanical testing of modified polyvinyl alcohol film samples of the present disclosure.

FIG. 6B is a graph of the results of FIG. 6A and TABLE 6.

FIG. 7A shows the TABLE 7 results of gas barrier testing of modified polyvinyl alcohol film samples of the present disclosure.

FIG. 7B is a graph of the results of FIG. 7A and TABLE 7.

### DETAILED DESCRIPTION

The present disclosure provides compositions and methods for producing modified PVOH resins that were unexpectedly found to exhibit improved oxygen barrier properties while also maintaining or improving upon other desirable features of the PVOH polymer, as described further herein.

In one aspect, PVOH resins may be modified with various co-monomers to produce either copolymers or terpolymers of PVOH. PVOH copolymers and terpolymers useful in embodiments disclosed herein may be formed via the copolymerization of a vinyl ester monomer and one or more selected comonomers via bulk polymerization, solution polymerization, emulsion polymerization, suspension polymerization, and the like.

Modified PVOH according to embodiments herein may include a first comonomer, such as a sulfonic acid containing comonomer. Examples of suitable sulfonic acid comonomers containing sulfonic acid groups may include but are not limited to vinyl sulfonic acid, allyl sulfonic acid, ethylene sulfonic acid, 2-acrylamido-1-methylpropanesulfonic acid, 2-acrylamido-2-methylpropanesulfonic acid (AMPS), 2-methacrylamido-2-methylpropanesulfonic acid, 2-sulfoethyl acrylate, and salts thereof, among others. In some embodiments, the sulfonic acid containing comonomer is preferably 2-acrylamido-2-methylpropanesulfonic acid (AMPS), to form a PVOH-co-AMPS copolymer. Optionally, additional second co-monomers may be added to form a terpolymer of PVOH, including but not limited to vinyl lactam, carboxylate, vinyl amine, vinyl amide, N-vinyl-2-pyrrolidone, methyl acrylate, itaconic acid or a derivative of itaconic acid, or a vinyl ester of versatic acid such as vinyl neodecanoate or vinyl neononanoate.

The sulfonic acid containing comonomers may be incorporated into the modified PVOH polymer in amounts ranging from about 0.1 to about 15 mol %, preferably from about 3 mol % to about 12 mol %, more preferably from about 3 mol % to about 5 mol %.

In another aspect, the modified PVOH resin of the present disclosure may be produced according to methods described herein to produce a block copolymer, or optionally a block terpolymer. A “blocky” or “block” polymer refers to a polymer that is composed of chemical blocks or segments of different chemical compositions arranged in a regular pattern along the polymer chain. Block polymers typically comprise two or more chemically distinct blocks or segments, which are covalently linked together in a linear chain. The blocks can have different compositions, molecular weights, and chain lengths, which can lead to a variety of different properties and behaviors of the block polymer. In the case of a PVOH-co-AMPS block copolymer, for example, the polymer may comprise segments or strings of hydroxyl (OH) groups and 2-acrylamido-2-methylpropanesulfonic acid (AMPS) groups along the polymer chain.

PVOH block copolymers described herein can be synthesized through a variety of different methods, including living polymerization, anionic polymerization, and controlled radical polymerization. These methods allow for precise control over the size, composition, and arrangement of the different blocks or segments in the polymer chain, which can lead to the creation of tailored materials with specific properties and functions.

An example of a controlled radical polymerization is taught by U.S. Patent Publication No. 2022/0267499A1 by Takayama et al., which discloses production of a vinyl ester-based block copolymer by performing controlled radical polymerization in the presence of a radical initiator and an organic cobalt complex (i.e., a “controller”) to regulate incorporation of an acrylic acid-based comonomer. However, the described method is time intensive (11 hour polymerization and 24 hour drying time), has a low conversion efficiency of around 22-32%, and requires the cobalt catalyst to be extracted prior to saponification, all of which increases the cost and complexity of resin production at commercial scale. This is in contrast to the method of the present disclosure described further herein, which is time efficient (total reaction time of 4 hours), utilizes a standard free-radical initiator with no controller or extraction steps needed, yields a high conversion efficiency of around 70-75%, and is easily scaled up for commercial production. Conversion efficiency refers to how much of the comonomer has been transformed into the polymer, in other words, how much comonomer has reacted and polymerized into the polymer chain.

The above-described vinyl ester monomers and comonomers of the present disclosure may be saponified after polymerization (described further herein), and the resulting modified PVOH including block copolymers or terpolymers may have a degree of hydrolysis measured by ¹³C NMR in the range from about 65% to about 99% in some embodiments; in the range from about 75% to about 95% in other embodiments, or more preferably in the range from about 94% to about 97%.

The modified PVOH including block copolymers or terpolymers according to embodiments herein may have a relative molecular weight indicated by a characteristic viscosity in the range from about 2 to about 60 cps, in some embodiments; in the range from about 10 to about 60 cps in other embodiments, in the range from about 3 to about 50 cps in yet other embodiments; or more preferably from about 14 to about 21 cps in further embodiments. The characteristic viscosity is determined on a 4 wt % solution of the polymer in water, measured on a Brookfield LV viscometer at 20° C. with spindle #18.

In one aspect, the sulfonic acid modified PVOH resins of the present disclosure may comprise a crystallinity of between about 10% to about 25%, or between about 12.5% to about 24.2% as measured by differential scanning calorimetry (DSC).

In another aspect, a sulfonic acid modified PVOH resin may comprise a blockiness index η of a sulfonic acid group of between about 0.2 to about 0.4, or between about 0.23 to about 0.36 according to the Modified Moritani Method described further herein.

In another aspect, sulfonic acid modified PVOH resin may comprise a sequence length of AMPS (I_{AMPS}) of between about 3.0 to about 5.5, or between about 3.3 to about 5.1, according to the Modified Moritani Method described further herein.

In another aspect, sulfonic acid modified PVOH resin may comprise a sequence length of OH (I_{OH}) of between about 28 to about 45, preferably about 30 to about 43, according to the Modified Moritani Method described further herein.

In another aspect, the sulfonic acid modified PVOH resin may comprise a DSC melting temperature (Tm) of about 190° C. to about 215° C., or between about 193° C. to about 214° C.

In another aspect, the sulfonic acid modified PVOH resin may comprise a DSC enthalpy of transition (ΔHₘ) of about 15 J/g to about 35 J/g, or between about 17.4 J/g to about 33.6 J/g.

In another aspect, the sulfonic acid modified PVOH resin may comprise a DSC crystallization temperature (T_{c}) of about 140° C. to about 190° C. or between about 144° C. to about 185° C. In another aspect, the sulfonic acid modified PVOH resin may comprise a DSC enthalpy of crystallization (ΔH_{c}) of about 22 J/g to about 35 J/g or between about 23 J/g to about 33 J/g.

In another aspect, a film may be made from the sulfonic acid modified PVOH resin via known techniques such as solution cast, extrusion, or other methods known in the art.

In another aspect, a film made from the sulfonic acid modified PVOH resin may have a disintegration time of between about 25 seconds to about 550 seconds, or between about 27 seconds to about 532 seconds, according to the Solubility Slide Frame Test Method described further herein.

In another aspect, a film made from the sulfonic acid modified PVOH resin may have a dissolution time of at least about 65 seconds, or at least about 68 seconds, according to the Solubility Slide Frame Test Method described further herein.

In another aspect, a film made from the sulfonic acid modified PVOH resin may have a tensile strength of about 60 MPa to about 85 MPa, or between about 65 MPa to about 82 MPa.

In another aspect, a film made from the sulfonic acid modified PVOH resin may have a break elongation of about about 40% to about 80%, or between about 44% to about 79%.

In another aspect, a film made from the sulfonic acid modified PVOH resin may have a 10% modulus of about 60 MPa to about 75 MPa, or between about 62 MPa and about 75 MPa.

In another aspect, a film made from the sulfonic acid modified PVOH resin may have an oxygen transmission rate (OTR) of about 15 cc/(m²·day) to about 21 cc/(m²·day), or between about 17.1 cc/(m²·day) to about 20.4 15 cc/(m²·day) according to ASTM standard F1927 at 75% relative humidity (RH) and 23° C.

### Experimental Methods and Examples

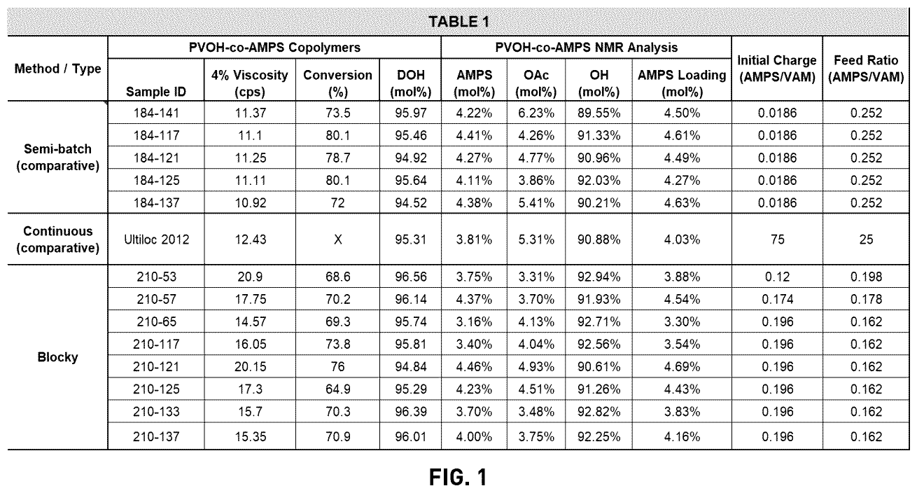

Samples of blocky PVOH-co-AMPS copolymers were prepared according to the following methods. To a 5 L jacketed reactor fitted with a condenser, mechanical stirrer and feed inlets was added an initial charge of vinyl acetate 451.2 g, 57.6 g of a 50% aqueous solution containing 28.8 g AMPS and methanol 120 g, giving an initial charge ratio of 0.1277 based on the weights of the AMPS 50% solution and vinyl acetate. The reactor was heated to 65° C. while stirring at 150 rpm. When the internal temperature reached 65° C., the initiator feed solution (Trigonox EHP, 1.44 g in MeOH, 280 g) was started at a feed rate of 1.56 g/min. After 30 minutes the delay feeds, AMPS 202.06 g (50% aqueous solution, 101.03 g contained) and vinyl acetate 1018.97 g were started at 1.35 g/min and 6.79 g/min, respectively (feed ratio=0.1983 based on vinyl acetate and AMPS @ 50% aqueous solution). The reaction was allowed to continue at 65° C. for 180 minutes, at this time the delay and initiator feeds were stopped. The polymerization continued for 60 minutes upon which the reactor was cooled down. The results of the polymerization are shown in FIG. 1 (TABLE 1). The resulting polymer paste solution was fed to a stripping column where methanol vapor was introduced to remove unreacted vinyl acetate. Afterwards solids were adjusted to 35 wt % with methanol. Sodium hydroxide (NaOH, 50% aq) was mixed with methanol to produce a 10 wt % solution. This was mixed into the polymer solution so that the mole ratio of NaOH and paste was 0.02. The mixture was put in a 40° C. water bath for 2 hours, and subsequently the saponified polymer was ground and dried in an 80° C. oven for 1.5 hours. The composition of each polymer sample was analyzed using NMR to generate the results in FIG. 1 (TABLE 1). Additional samples were produced with the initial and delay feed ratios as shown in FIG. 1 (TABLE 1).

For the blocky sample 210-125, VAM and AMPS monomers were fed for alternating periods of time to verify that this method would also successfully produce a blocky copolymer. More specifically, the procedure used to produce the blocky co-AMPS was repeated except the delay feeds were alternated every 25 minutes until the end of the feeds were reached. To a 5 L jacketed reactor fitted with a condenser, mechanical stirrer and feed inlets was added an initial charge of vinyl acetate 647.7 g, AMPS 126.72 g of a 50% aqueous solution, containing 63.3 g of AMPS and methanol 176 g, giving an initial charge ratio of 0.1957 based on the weights of the AMPS 50% solution and vinyl acetate. The reactor was heated to 65° C. while stirring at 150 rpm. When the internal temperature reached 65° C. the initiator feed solution (Trigonox EHP, 1.44 g in MeOH, 224 g) was started at a feed rate of 1.25 g/min. After 30 minutes delay feeds were alternated as follows, Vinyl acetate was fed for 25 minutes then stopped, AMPS fed for 25 minutes. This cycle was repeated for a total of 6 times (150 minutes). Delay feeds were AMPS 132.94 g (50% aqueous solution, 101.0366.47 g contained) and vinyl acetate 822.49 g, feed rates were 1.77 g/min and 10.97 g/min, respectively (feed ratio=0.1616 based on vinyl acetate and AMPS @ 50% aqueous solution). The reaction was allowed to continue at 65° C. for 180 minutes, at this time the delay and initiator feeds were stopped. The polymerization continued for 60 minutes upon which the reactor was cooled down. The results of the polymerization are shown in FIG. 1 (TABLE 1). The resulting polymer paste solution was fed to a stripping column where methanol vapor was introduced to remove unreacted vinyl acetate. Afterwards solids were adjusted to 35 wt % with methanol. Sodium hydroxide (NaOH, 50% aq) was mixed with methanol to produce a 10 wt % solution. This was mixed into the polymer solution so that the mole ratio of NaOH and paste was 0.02. The mixture was put in a 40° C. water bath for 2 hours, and subsequently the saponified polymer was ground and dried in an 80° C. oven for 1.5 hours. The composition of each polymer sample was analyzed using NMR to generate the results in FIG. 1 (TABLE 1).

Further, comparative examples of commercially available PVOH-co-AMPS copolymer were obtained, sold under the name Ultiloc 2012 (U2012) by the applicant of the present disclosure, Sekisui Specialty Chemicals America LLC. The Ultiloc 2012 commercial comparative examples were produced by a continuous polymerization method, such as described in U.S. Pat. No. 6,818,709B1 by the same applicant and named inventor of the present disclosure, and analyzed using NMR to generate the results in FIG. 1 (TABLE 1). For the continuous comparative example, the initial charge of 75 and feed ratio of 25 refers to using 75% in the first reactor and 25% in the second reactor of that process to prevent compositional drift due to the difference in reactivity ratios.

Further comparative examples of standard, non-blocky PVOH-co-AMPS copolymers were made according to a standard semi-batch process. To a 5 L jacketed reactor fitted with a condenser, mechanical stirrer and feed inlets was added an initial charge of vinyl acetate 475.6 g, 8.83 g of a 50% aqueous solution containing 4.42 g AMPS and methanol 120 g, giving an initial feed ratio of 0.0186 based on the weights of the AMPS 50% solution and vinyl acetate. The reactor was heated to 65° C. while stirring at 150 rpm. When the internal temperature reached 65° C. the initiator feed solution (Trigonox EHP, 1.44 g in MeOH, 280 g) was started at a feed rate of 1.56 g/min. After 30 minutes the delay feeds, AMPS 250.83 g (50% aqueous solution, 125.42 g contained) and vinyl acetate 994.59 g were started at 1.67 g/min and 6.63 g/min, respectively (feed ratio=0.252 based on vinyl acetate and AMPS@50% aqueous solution). The reaction was allowed to continue at 65° C. for 180 minutes, at this time the delay and initiator feeds were stopped. The polymerization continued for 60 minutes upon which the reactor was cooled down. The results of the polymerization are shown in FIG. 1 (TABLE 1). The resulting polymer paste solution was fed to a stripping column where methanol vapor was introduced to remove unreacted vinyl acetate. Afterwards, solids were adjusted to 35 wt % with methanol. Sodium hydroxide (NaOH, 50% aq) was mixed with methanol to produce a 10 wt % solution. This was mixed into the polymer solution so that the mole ratio of NaOH and paste was 0.02. The mixture was put in a 40° C. water bath for 2 hours, and subsequently the saponified polymer was ground and dried in an 80° C. oven for 1.5 hours. The composition of each polymer sample was analyzed using NMR to generate the results in FIG. 1 (TABLE 1).

FIG. 1 (TABLE 1) shows the results of polymerization including solution viscosity and ¹³C NMR compositional analysis of blocky PVOH-co-AMPS copolymer samples produced according to the method described above. TABLE 1 further includes the results and compositional analysis of non-blocky PVOH-co-AMPS comparative examples produced and obtained as described above.

15% and 4% solution viscosity were measured using a Brookfield LV Viscometer at 20° C. with spindle #18.

Conversion % was calculated and measured by gravimetric analysis after the polymerization was completed.

Polymer compositions, degree of hydrolysis and blockiness index were measured using ¹³C NMR on a Bruker Avance 400 MHz NMR machine in deuterated water at 7-8 wt %.

As can be seen from the results of FIG. 1 (TABLE 1), the blocky PVOH-co-AMPS copolymer samples produced were compositionally consistent with the comparative examples, including but not limited to viscosity, degree of hydrolysis, AMPS mole %, acetate mole %, and hydroxyl mole %, for example, despite the difference in methodology used to produce the blocky samples versus comparative examples, such as the large difference in initial charge of the monomers and feed ratios. It was unexpected that such a large initial charge of AMPS monomers would result in a successful polymerization, because the AMPS monomer has a higher reactivity and polymerizes faster than the vinyl acetate monomer (VAM), typically resulting in a poly-AMPS structure precipitating out of the methanol and gumming up the reactor. It was discovered that an initial charge of about 0.196 AMPS/VAM led to a stable polymerization yielding the blocky PVOH-co-AMPS copolymers of TABLE 1, beyond which would result in too much insoluble matter.

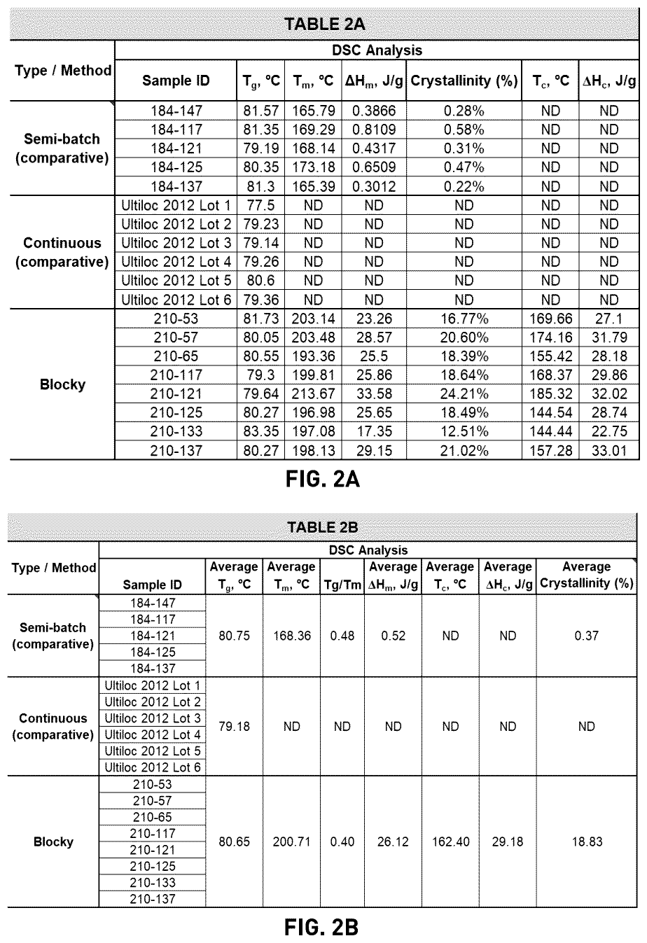

As shown in FIG. 2A (TABLE 2A), despite the compositional similarity between the blocky PVOH-co-AMPS samples and comparative examples, differential scanning calorimetry (DSC) analysis revealed some surprising differences. DSC analysis was performed on the samples and comparative examples using a TA Instrument DSC Q20 V24.11 Build 124, DSC Standard, Modulated FC, and Universal V4.5A program was use to analyze the data. The following method log was used: (1) Ramp 10.00° C./min to 250.00° C.; (2) Mark end of cycle 0; (3) Ramp 5.00° C./min to 40.00° C.; (4) Mark end of cycle 0; (5) Ramp 10.00° C./min to 250.00° C.; (6) Mark end of cycle 0; (7) End of method.

It was unexpectedly discovered that the blocky PVOH-co-AMPS samples resulted in a much higher degrees of crystallinity than the comparative examples, both commercial (continuous polymerization method) and lab produced (semi-batch method). Further, although glass transition temperatures (T_{g}) were similar between the blocky samples and comparative examples, the melting temperature (Tₘ) and enthalpy of transition (ΔHₘ) was quite different and significantly higher for the blocky samples, which was consistent with the higher crystallinity present in the blocky samples.

FIG. 2B (TABLE 2B) shows a further analysis of the data of FIG. 2A (TABLE 2A), including calculating average values for the comparative examples and blocky samples. As can be appreciated from the data, the average Tₘ is higher for the blocky samples, as well as the average ΔHₘ and average crystallinity, despite having nearly identical T_{g}. For the Ultiloc 2012 commercial comparative example, crystallinity and Tg could not be detected because the polymer was not crystalline.

To further elucidate the properties of the blocky samples, the blockiness index of the blocky samples and Ultiloc 2012 comparative example was measured and calculated as described further below. The blockiness index of a blocky polymer is a measure of the degree of blockiness or regularity of the polymer chain, in other words, a quantitative measure of the regularity of the arrangement of the different blocks or segments in a block polymer, including copolymers and terpolymers. Further, the sequence length of a particular chemical group or block of interest was also determined as described below.

### Moritani Method

The method of calculating the blockiness index for the purposes of the present disclosure was modified from the teachings of, “¹³C- and ¹H-NMR Investigations of Sequence Distribution in Vinyl Alcohol-Vinyl Acetate Copolymers,” Macromolecules 10(3), 532-535 (1977); which is hereby incorporated by reference in its entirety.

First using the method described by Moritani, blockiness index was calculated for the blocky samples versus comparative examples based on the ¹³C NMR spectral analysis of those samples. Moritani provides a blockiness index as calculated by the following equation of Formula 1 based on the integral peaks of the OH—OH (Peak A), OH—OAc (Peak B), and OAc—OAc (Peak C) dyads, based on integration limits from partially hydrolyzed grades as Moritani describes. The lower the value of η, the higher the blockiness or blocky character of the polymer.

$$\begin{matrix}{ℓ}_{OAc} = \frac{2 ( OAc )}{( OH . OAc )}\end{matrix} \qquad Formula 1$$

Structurally, peaks A, B and C may be represented as follows (from left to right respectively):

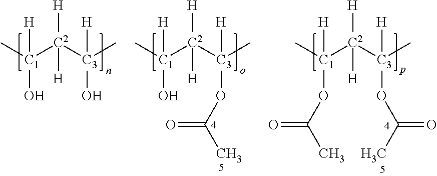

and the following integration limits:

Integration limits

| Peak | Integration |
|---|---|
| A | 45.34-42.69 |
| B | 42.31-40.43 |
| C | 40.16-38.67 |

Sequence lengths of the OH and OAc groups were also calculated according to the method of Moritani, and the following equations of Formula 2A and Formula 2B respectively.

$$\begin{matrix}{ℓ}_{OH} = \frac{2 ( OH )}{( OH . OAc )}\end{matrix} \qquad Formula 2 A$$

$$\begin{matrix}{ℓ}_{OAc} = \frac{2 ( OAc )}{( OH . OAc )}\end{matrix} \qquad Formula 2 B$$

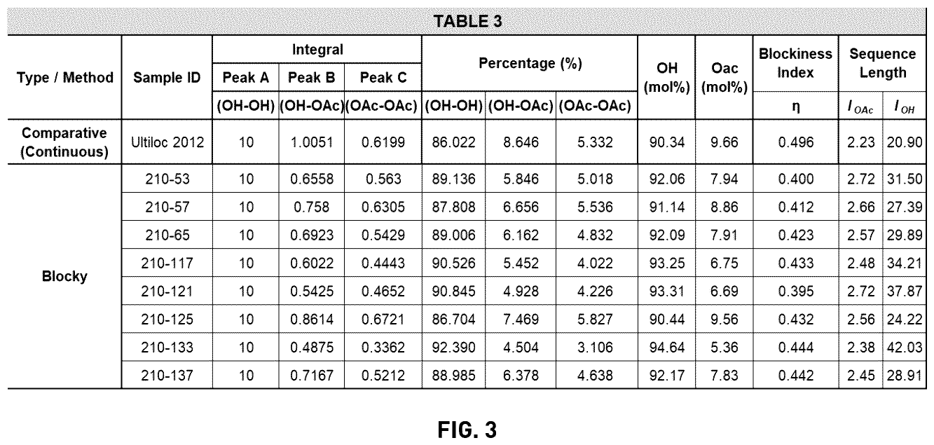

As shown in the results of FIG. 3 (TABLE 3), there was not an appreciable difference in the blockiness index η between the comparative Ultiloc 2012 PVOH-co-AMPS copolymer and the blocky PVOH-co-AMPS copolymers samples produced, however, the Moritani method only factors in the OH—OH (Peak A), OH—OAc (Peak B), and OAc—OAc (Peak C) dyads into the analysis, and does not account for the potential blocky character of the AMPS group in the copolymer. Accordingly, the method was modified to include additional integral peaks as described further below. For the comparative Ultiloc 2012 example, the data of TABLE 3 represents the results of averaging the measurements of the 6 lots of Ultiloc 2012 shown in TABLE 2A and 2B.

With respect to the sequence lengths, it can be seen that the sequence lengths for OH groups (l_{OH}) were significantly longer in the blocky PVOH-co-AMPS samples than for the comparative Ultiloc 2012 commercial example, while the sequence lengths of OAc (l_{OAc}) groups were about equivalent.

### Modified Moritani Method

To account for the AMPS groups in the determination of blockiness, the Moritani method for calculating blockiness index η as well as sequence lengths was then modified to include new integration limits that covered the contribution of the AMPS dyads, as defined by new Peak D, Peak E, and Peak F below (from left to right):

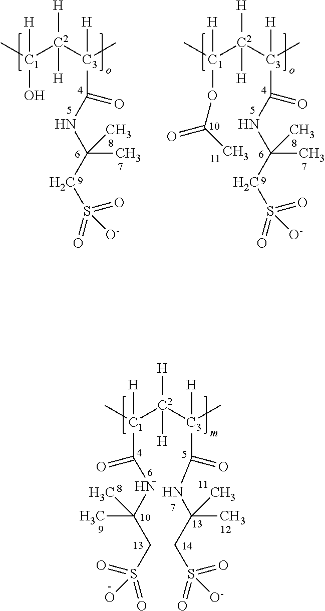

Integration limits for Peaks D, E and F were defined as follows in the table below:

Integration limits

| Peak | Integration |
|---|---|
| A | 45.34-42.69 |
| B | 42.31-40.43 |
| C | 40.16-38.67 |
| D | 41.32-40.16 |
| E | 39.47-37.7 |
| F | 33.81-31.84 |

The following calculation of Formula 3 modified from the Moritani method was used to determine blockiness index η of the samples based on the AMPS dyads of peaks D, E and F to create a blockiness index for the PVOH-co-AMPS copolymers:

$$η = \frac{( OH , AMPS ) \times 100}{2 ( AMPS ) ( OH )} \qquad Formula 3$$

Further, the following calculation method was modified from the method of Moritani to determine sequence length of the AMPS monomer groups in addition to the standard sequence length equations:

$${}^{ℓ} AMPS = \frac{2 ( AMPS )}{( OH . AMPS )} \qquad Formula 4$$

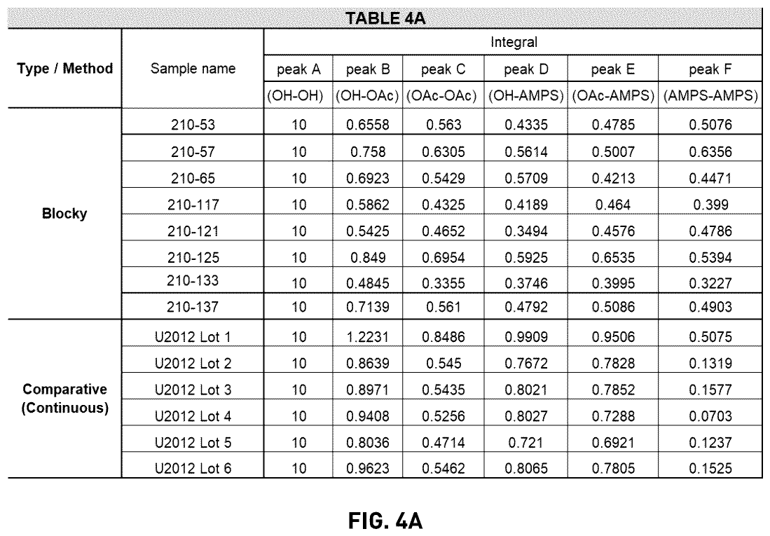

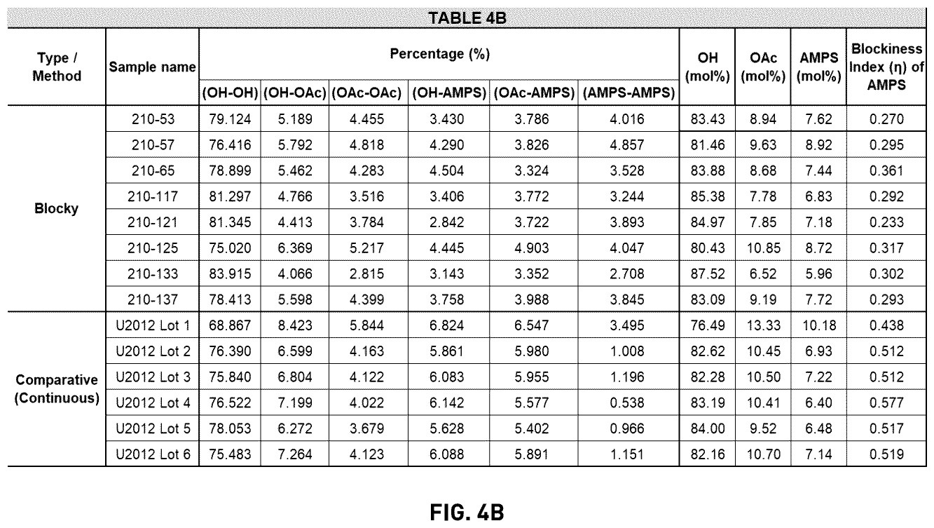

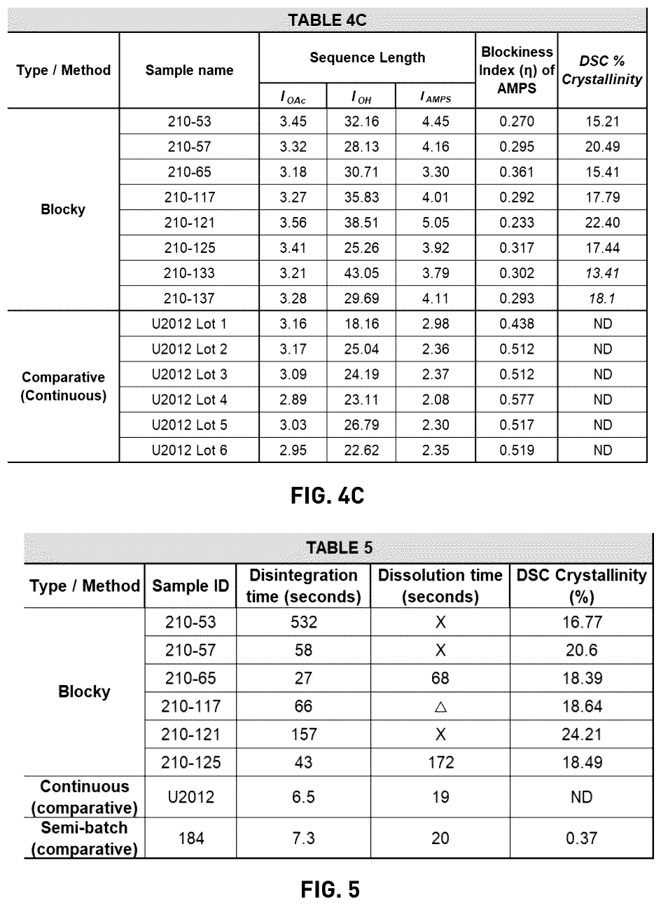

FIG. 4A (TABLE 4A) shows the integral peak measurement results for new peaks D, E and F, as well as the original measurements for peaks A, B and C.

FIG. 4B (TABLE 4B) shows the results of calculating the blockiness index of the blocky PVOH-co-AMPS samples as well as the six lots of comparative Ultiloc 2012 commercial samples using the Modified Moritani Method described above. As can be seen from the results, the blockiness of the blocky samples was considerably higher (i.e., the η value considerably lower) than the comparative commercial examples of Ultiloc 2012. In other words, the AMPS groups as represented by the structures of Peaks D, E and F were shown to be present in the polymer in blocks or segments along the polymer chain.

FIG. 4C (TABLE 4C) shows the results of the sequence length calculations including for the AMPS groups or dyads according to the Modified Moritani Method. For ease of review, the blockiness index η from FIG. 4B (TABLE 4B) is provided, alongside the DSC % Crystallinity results from FIG. 2A (TABLE 2A) as well. As can be seen from TABLE 4C, the sequence lengths of both the OH (I_{OH}) as well as the AMPS (I_{AMPS}) groups are substantially longer than the comparative commercial examples of Ultiloc 2012. This increase in blockiness and sequence lengths is consistent with the blockiness index values shown in TABLE 4C and discussed previously, and furthermore correlate with the high degree of crystallinity for the blocky samples, compared with no measurable crystallinity of the comparative Ultiloc 2012 examples via DSC analysis.

Based on the extensive ¹³C NMR, blockiness index, chain length and other analysis of these blocky PVOH-co-AMPS samples, it is proposed that the basic polymer structure and repeat units, blocks or segments may be described by the following structure:

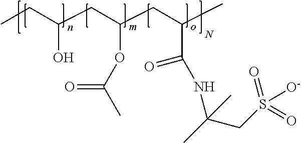

wherein n may comprise between about 15 to about 40, m may comprise between about 3 to about 4, and o may comprise between about 3.5 to about 6.

### Film Sample Preparation Method

Samples of film were prepared using the blocky PVOH-co-AMPS resin samples described above in addition to the comparative Ultiloc 2012 commercial examples. Films were prepared by casting a 15% aqueous solution onto a glass plate, which was leveled by gravity and allowed to dry to a moisture content of about 6 to 15% which may take from 2 to 7 days. An amount of the solution was added to the plate to provide for a film with a target thickness of about 50 μm.

### Solubility Slide Frame Test Method

The blocky PVOH-co-AMPS samples were tested for disintegration and dissolution performance according to the Solubility Slide Frame Test Method described as follows.

A 2.3×3.4 cm sample of each film was mounted in a slide frame and placed in a 600 ml beaker having a 100 mm diameter and filled with 400 ml water. The beaker was placed on a magnetic stirrer, and the water was stirred with a 50 mm long magnetic stir bar until the vortex reached the 400 mL mark on the beaker. The water temperature was maintained at 23° C.+/−1° C. The frame was secured in the beaker with a clamp which was supported by a platform such that stirring water pushed against the film, and the film began to balloon or wave. The disintegration time was recorded as the moment when the film balloon burst. The frame remained in water for a total of 10 minutes from the start of the test, and the dissolution time was recorded as the total time (inclusive of disintegration time) when no residual strings of film and no film particles remained on the frame. The stopwatch was started as soon as the slide frame entered the moving water. An average of two samples were taken for each measurement, and the values were normalized to a film thickness of 50 μm.

The results of the Solubility Slide Frame Test Method are shown in FIG. 5 (TABLE 5) for the films made from each blocky and a comparative (continuous) resin sample. An “X” denotes that the sample did not dissolve within the 10 minute test period, whereas the “Δ” denotes the sample almost dissolved within 10 minutes but small pieces remained in the water. Further, the DSC Crystallinity for each sample is provided for reference, with “ND” denoting “none detected.” As can be appreciated from the results, the highly crystalline blocky PVOH-co-AMPS samples were not very soluble, meaning they performed worse than the comparative example for both disintegration and dissolution time, which is consistent for highly crystalline polymers.

### Mechanical Properties

Films made from the blocky PVOH-co-AMPS samples and comparative commercial example as described previously were tested for mechanical properties, including tensile strength, 10% modulus, and break elongation %.

Tensile strength, 10% modulus, and break elongation % was measured according to ASTM D882, “Standard Test Method for Tensile Properties of Thin Plastic Sheeting,” using an INSTRON tensile testing apparatus (Model 5544 Tensile Tester or equivalent). A minimum of five test specimens, each cut with reliable cutting tools to ensure dimensional stability and reproducibility, were tested for each measurement and the average was calculated. Tests were conducted in a standard laboratory atmosphere of 23+2.0° C. and 50+5% relative humidity. Samples were cut to the following dimensions, width (15 mm)×length (6 cm) samples of a single film sheet having a thickness shown in Table 6 were prepared. The samples were then transferred to the INSTRON tensile testing machine to proceed with testing while minimizing exposure in the 50% relative humidity environment. The tensile testing machine was prepared according to manufacturer instructions, equipped with a 500 N load cell, and calibrated. The correct grips and faces were fitted (INSTRON grips having model number 2702-032 faces, which are rubber coated and 25 mm wide), and the samples were mounted into the tensile testing machine and analyzed.

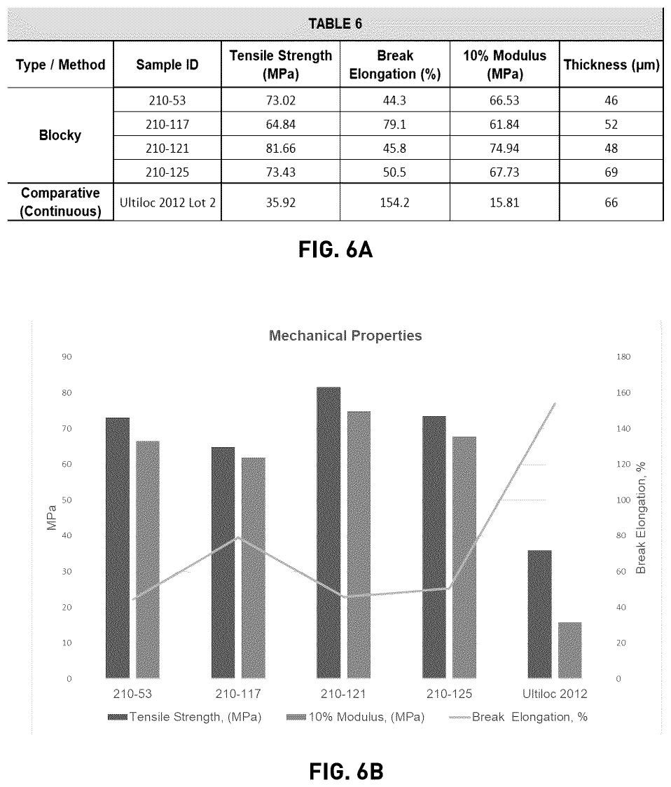

The results of the testing are shown in FIG. 6A (TABLE 6), as well as the graph of that data in FIG. 6B.

As can be appreciated from these results, both the tensile strength and modulus were significantly higher for the blocky PVOH-co-AMPS film samples than the comparative commercial example of U2012, whereas the break elongation % was much lower for the blocky samples than the comparative. These results were consistent with the higher degree of crystallinity for the blocky PVOH-co-AMPS samples versus the comparative example.

### Gas Barrier Performance

Films made from the blocky PVOH-co-AMPS samples and comparative commercial example were tested for gas barrier performance, specifically humidified OTR and permeability. Further, an additional comparative commercial example was obtained for testing, namely a PVOH homopolymer sold under the name Selvol 107 by the applicant of the present disclosure, Sekisui Specialty Chemicals America LLC. Selvol 107 is a highly crystalline, low viscosity fully hydrolyzed (about 98% degree of hydrolysis) PVOH homopolymer which is known to have good OTR performance, i.e. low oxygen transmission rates.

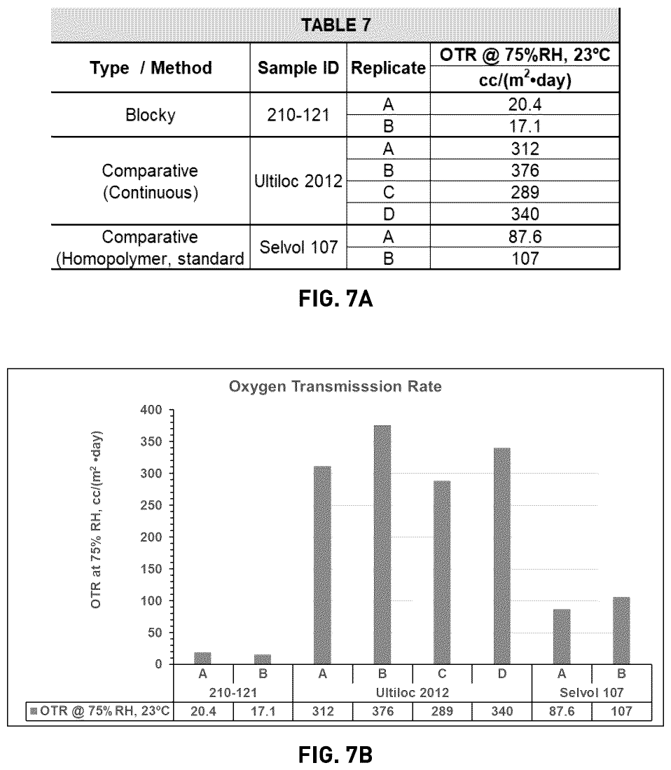

A third party accredited laboratory performed the testing according to ASTM standard F1927. Films for gas barrier testing were prepared as follows. Samples were all 15% solids and coated with a #12 Mayer Rod, dried for 15 minutes in an oven @ 85 C, then conditioned in a controlled temperature and humidity (CTH) room overnight. BOPP was corona treated for 2 minutes before drawing down the film. Sample thickness was 10 microns (total of 50 micron BOPP+10 micron sample). Oxygen transmission rates were measured according to ASTM F1927 at 75% RH on an Oxtran Oxygen Permeability Instrument. A minimum of two samples for each film were measured. The OTR and permeability values were reported at steady state as shown in TABLE 7 (FIG. 7A) and FIG. 7B. Steady state was defined as a value that changes ≤1% over 24 hours. Further details of the test conditions are provided in the table OTR TEST CONDITIONS below.

OTR TEST CONDITIONS

| | | | |
|---|---|---|---|
| Test gas | Oxygen | Test Temp. | 23° C. |
| Test gas concentration | 100% O₂ | Carrier Gas | 98% N₂, 2% H₂ |
| Test gas humidity | 75% RH | Carrier gas humidity | 0% RH |
| Test gas pressure | 760 mmHg | | |
| Film Thickness | 10 μm | BOPP thickness | 50 μm |

The results of the testing are shown in FIG. 7A (TABLE 7) as well as the graph of FIG. 7B. As can be appreciated from the results, the blocky PVOH-co-AMPS sample performed unexpectedly well having an extremely low OTR value compared with not only the commercial Ultiloc 2012 PVOH-co-AMPS copolymer, but even as compared with the fully hydrolyzed PVOH homopolymer Selvol 107. This was particularly unexpected given the high relative humidity of 75%.

The inventors of the present disclosure have succeeded at producing a novel blocky sulfonic-acid modified PVOH polymer that has strong oxygen barrier performance while also exhibiting other beneficial features such as mechanical strength. The modified PVOH, though less soluble than comparative examples, may nonetheless be solubilized if needed such as at high temperatures, and utilized alone or in blended formulations with other polymers or additives, for example.

Further, it was unexpected that the method of producing the blocky polymers described herein resulted in a successful polymerization, both due to the high initial charge of reactive monomers and typical tendency to encounter precipitates as described above, but also due to the fact that a controller such as cobalt was not needed in addition to the standard free radical peroxide initiator. The blocky PVOH-co-AMPS sample polymers resulting from the synthesis method described herein were shown to have the same general composition as the comparative commercial copolymers, yet surprisingly different performance features as a result of the higher degree of crystallinity, blockiness, chain length and other factors described in detail above. Further, it may be appreciated by those skilled in the art that the Modified Moritani Method described herein is not limited to calculating a blockiness index for AMPS groups in particular, and the method may easily be adapted to any sulfonic acid modified group.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A sulfonic acid modified polyvinyl alcohol resin comprising:
from about 3 mol % to about 12 mol % of a comonomer comprising a sulfonic acid group; and
a blockiness index η of the sulfonic acid group of between about 0.2 to about 0.4 according to a Modified Moritani Method.

2. The sulfonic acid modified polyvinyl alcohol resin of claim 1, further comprising a crystallinity of between about 10% to about 25% as measured by differential scanning calorimetry (DSC).

3. The sulfonic acid modified polyvinyl alcohol resin of claim 1, further comprising a sequence length I_{AMPS} of between about 3.0 to about 5.5 according to the Modified Moritani Method.

4. The sulfonic acid modified polyvinyl alcohol resin of claim 1, further comprising a sequence length I_{OH} of between about 28 to about 45 according to the Modified Moritani Method.

5. The sulfonic acid modified polyvinyl alcohol resin of claim 1, further comprising a DSC melting temperature (Tₘ) of about 190° C. to about 215° C.

6. The sulfonic acid modified polyvinyl alcohol resin of claim 1, further comprising a DSC enthalpy of transition (ΔHₘ) of about 15 J/g to about 35 J/g.

7. The sulfonic acid modified polyvinyl alcohol resin of claim 1, further comprising a DSC crystallization temperature (T_{c}) of about 140° C. to about 190° C.

8. The sulfonic acid modified polyvinyl alcohol resin of claim 1, further comprising a DSC enthalpy of crystallization (ΔH_{c}) of about 22 J/g to about 35 J/g.

9. The sulfonic acid modified polyvinyl alcohol resin of claim 1, wherein the sulfonic acid group is selected from the group consisting of vinyl sulfonic acid, allyl sulfonic acid, ethylene sulfonic acid, 2-acrylamido-1-methylpropanesulfonic acid, 2-acrylamido-2-methylpropanesulfonic acid (AMPS), 2-methacrylamido-2-methylpropanesulfonic acid, 2-sulfoethyl acrylate, and salts thereof.

10. The sulfonic acid modified polyvinyl alcohol resin of claim 1, wherein the sulfonic acid group comprises 2-acrylamido-2-methylpropanesulfonic acid (AMPS).

11. The sulfonic acid modified polyvinyl alcohol resin of claim 1, wherein the modified polyvinyl alcohol is a terpolymer comprising the sulfonic acid group and an additional comonomer.

12. The sulfonic acid modified polyvinyl alcohol resin of claim 11, wherein the additional comonomer is selected from the group consisting of vinyl lactam, carboxylate, vinyl amine, vinyl amide, N-vinyl-2-pyrrolidone, methyl acrylate, itaconic acid or a derivative of itaconic acid, or a vinyl ester of versatic acid.

13. A film comprising the sulfonic acid modified polyvinyl alcohol resin of claim 1.

14. The film of claim 13, further comprising a disintegration time of between about 25 seconds to about 550 seconds according to a Solubility Slide Frame Test Method.

15. The film of claim 14, further comprising a dissolution time of at least about 65 seconds according to the Solubility Slide Frame Test Method.

16. The film of claim 13, further comprising a tensile strength of about 60 MPa to about 85 MPa.

17. The film of claim 13, further comprising a break elongation of about 40% to about 80%.

18. The film of claim 13, further comprising a 10% modulus of about 60 MPa to about 75 MPa.

19. The film of claim 13, further comprising an oxygen transmission rate (OTR) of about 15 cc/(m²·day) to about 21 cc/(m²·day) according to ASTM standard F1927 at 75% relative humidity (RH) and 23° C.
